(19) United States
(12) Patent Application Publication
(10) Pub. No.: US 2007/0077074 A1
(43) Pub. Date: Apr. 5, 2007

(54) Apparatuses and methods for identifying a consumable for use with an imaging apparatus

(75) Inventors: Christopher A. Adkins, Lexington, KY (US); Douglas K. Peterson JR., Irvine, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/241,117

(22) Filed: Sep. 30, 2005

(51) Int. Cl. G03G 15/00

(52) U.S. Cl. 399/12

(57) ABSTRACT

Apparatuses and methods for identifying consumables intended for use in an imaging apparatus, such as consumables having a memory storing at least first data and second data. One such method involves incrementing the first data during printing operations using the imaging apparatus; the imaging apparatus determining when the first data corresponds to a first predetermined value; and setting the second data to a second predetermined value based on a correspondence of the first data to the first predetermined value.

### BACKGROUND OF THE INVENTION

1. Field of the Invention

The present invention relates to imaging, and, more particularly, to methods and apparatuses for identifying consumables for use with an imaging apparatus.

2. Description of the Related Art

An imaging device typically employs one or more consumables, such as, for example, replaceable inkjet printhead cartridges or laser toner cartridges.

Counterfeits of original equipment manufacturer (OEM) cartridges are often fraudulently packaged to appear as an authentic new OEM cartridge (e.g., as opposed to a previously used OEM cartridge that has been remanufactured or refilled by an entity other than the OEM), but may actually be re-manufactured or refilled using inferior materials and processes, and may include an inferior colorant. The use of such counterfeit cartridges can result in a reduced quality of printed output of the imaging device, which is undesirable to the consumer. In addition, the use of inferior colorants may damage or clog the colorant dispersal systems, further degrading performance of the imaging device, which is also undesirable to the consumer, and contributes to an unpleasant printing experience. Moreover, OEMs may desire to institute a rewards program, wherein aspects of a consumable's history may affect its treatment under such a program, such as whether it was an authentic new OEM consumable when first installed in a particular imaging apparatus.

What is needed in the art is an improved method for identifying consumables for use with an imaging apparatus.

### SUMMARY OF THE INVENTION

The invention, in one exemplary embodiment, relates to a method for identifying a consumable intended for use with an imaging apparatus. Such a consumable might have memory storing at least first data and second data. The method includes incrementing the first data during printing operations using the imaging apparatus; the imaging apparatus determining when the first data corresponds to a first predetermined value; and setting the second data to a second predetermined value based on a correspondence of the first data to the first predetermined value.

The invention, in another exemplary embodiment, relates to a method for identifying a consumable intended for use with an imaging apparatus. Such a consumable might have memory storing data and a serial number. The method includes installing a consumable into the imaging apparatus; reading the data from the memory; determining if the consumable is new to the imaging apparatus based on the serial number; and determining if the data corresponds to a predetermined value.

The invention, in still another exemplary embodiment, relates to an imaging apparatus configured to identify a consumable intended for use with the imaging apparatus. The consumable may have memory storing at least first data and second data. The imaging apparatus includes a print engine configured to receive a consumable; and a controller communicatively coupled to the print engine. The controller is configured to execute instructions for: determining when the first data corresponds to a first predetermined value; and setting the second data to a second predetermined value based on a correspondence of the first data to the first predetermined value.

The invention, in yet another exemplary embodiment, relates to an imaging apparatus for identifying a consumable intended for use with the imaging apparatus. Such a consumable may have memory storing data and a serial number. The imaging apparatus includes a print engine configured to receive a consumable; and a controller communicatively coupled to the print engine. The controller is configured to execute instructions for reading the data from the memory after a consumable is installed into the imaging apparatus; determining if the consumable is new to the imaging apparatus based on the serial number; and determining if the data corresponds to a predetermined value.

### BRIEF DESCRIPTION OF THE DRAWINGS

The above-mentioned and other features and advantages of this invention, and the manner of attaining them, will become more apparent and the invention will be better understood by reference to the following description of exemplary embodiments of the invention taken in conjunction with the accompanying drawings, wherein:

FIG. 1 is a diagrammatic depiction of an imaging system in accordance with an embodiment of the present invention.

FIG. 2 is a flowchart representing an aspect of a method for identifying consumables for use with an imaging apparatus in accordance with an embodiment of the present invention.

FIG. 3 is a flowchart representing another aspect of the method for identifying consumables of FIG. 2.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF EXEMPLARY EMBODIMENTS OF THE INVENTION

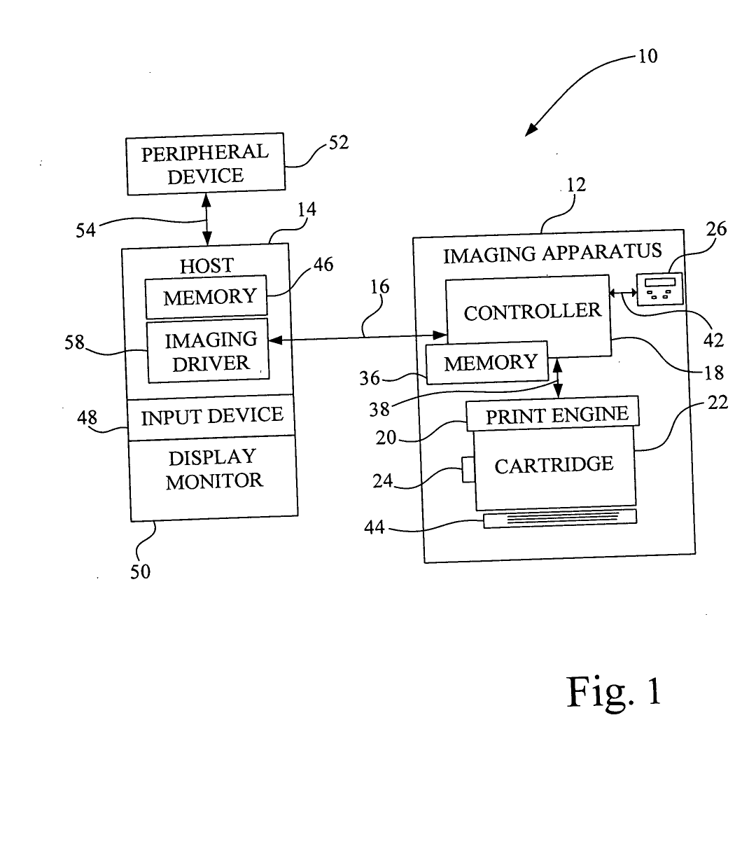

Referring now to the drawings, and particularly to FIG. 1, there is shown a diagrammatic depiction of an imaging system 10 in accordance with an embodiment of the present invention. Imaging system 10 includes an imaging apparatus 12 and a host 14. Imaging apparatus 12 communicates with host 14 via a communications link 16.

Imaging apparatus 12 may be, for example, an ink jet printer and/or copier, an electrophotographic (EP) printer and/or copier, or an all-in-one (AIO) unit that includes a printer, a scanner, and possibly a fax unit. Imaging apparatus 12 includes a controller 18, a print engine 20, a consumable (e.g., a replaceable cartridge 22 having cartridge memory 24), and a user interface 26. Cartridge 22 may be, for example, an inkjet printhead cartridge, an ink cartridge, an EP cartridge, or any consumable or user-replaceable component of imaging apparatus 12.

Controller 18 is communicatively coupled to print engine 20, and print engine 20 is configured to mount cartridge 22.

Controller 18 includes a processor unit and associated memory 36, and may be formed as one or more Application Specific Integrated Circuits (ASIC). Controller 18 may be a printer controller, a scanner controller, or may be a combined printer and scanner controller, for example, such as for use in a copier. Although controller 18 is depicted as residing in imaging apparatus 12, alternatively, it is contemplated that all or a portion of controller 18 may reside in host 14. Nonetheless, as used herein, controller 18 is considered to be a part of imaging apparatus 12. Controller 18 communicates with print engine 20, cartridge 22, and cartridge memory 24 via a communications link 38, and with user interface 26 via a communications link 42. Controller 18 serves to process print data, to operate print engine 20 during printing, and to execute instructions for identifying cartridges 22, and to identify a cartridge 22 installed in imaging apparatus 12.

Memory 36 stores various data pertaining to imaging apparatus 12, and also stores data pertaining to each particular cartridge 22 that has been installed in imaging apparatus 12, including a list of serial numbers data that have been previously installed in the particular imaging apparatus 12.

In the context of the examples for imaging apparatus 12 given above, print engine 20 may be, for example, an ink jet print engine or an electrophotographic print engine, configured for forming an image on a substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates cartridge 22 to eject ink droplets onto substrate 44 in order to reproduce text or images, etc. Alternatively, cartridge 22 may take the form of an ink cartridge that supplies ink to a separate printhead of print engine 20 for ejecting ink droplets onto substrate 44. As an electrophotographic print engine, print engine 20 causes cartridge 22 to deposit toner onto substrate 44, which is then fused to substrate 44 by a fuser (not shown). In the embodiment depicted, imaging apparatus 12 is an ink jet unit.

Host 14 may be, for example, a personal computer, including memory 46, an input device 48, such as a keyboard, and a display monitor 50. One or more of a peripheral device 52, such as a digital camera, may be coupled to host 14 via communication links, such as communication link 54. Host 14 further includes a processor, input/output (I/O) interfaces. Memory 46 may be any or all of RAM, ROM, NVRAM, or any available type of computer memory, and may include one or more of a mass data storage device, such as a floppy drive, a hard drive, a CD drive and/or a DVD drive. As set forth above, memory 36 of imaging apparatus 12 stores data pertaining to each particular cartridge 22 that has been installed in imaging apparatus 12. However, it is alternatively contemplated that memory 46 of host 14 may store such data.

During operation, host 14 includes in its memory 46 a software program including program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and host 14, and provides formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12.

In accordance with an embodiment of the present invention, cartridge memory 24 may be utilized to identify the cartridge. Data stored in cartridge memory 24 for the same exists in the form of colorant usage data (“gas gauge” data), the existing unique cartridge serial number, and an authentication code and a hidden authentication code that are used for authenticating cartridge 22 in conjunction with the cartridge's serial number.

The colorant usage data pertains to the usage of cartridge 22 in an imaging apparatus, such as imaging apparatus 12. For example, the colorant usage data may store a multiple of the number of nozzle firings executed by cartridge 22 while printing in an imaging apparatus. In addition, the usage data indicates whether cartridge 22 has reached a particular usage threshold. In the present embodiment, the usage threshold pertains to the exhaustion of the supply of ink in cartridge 22.

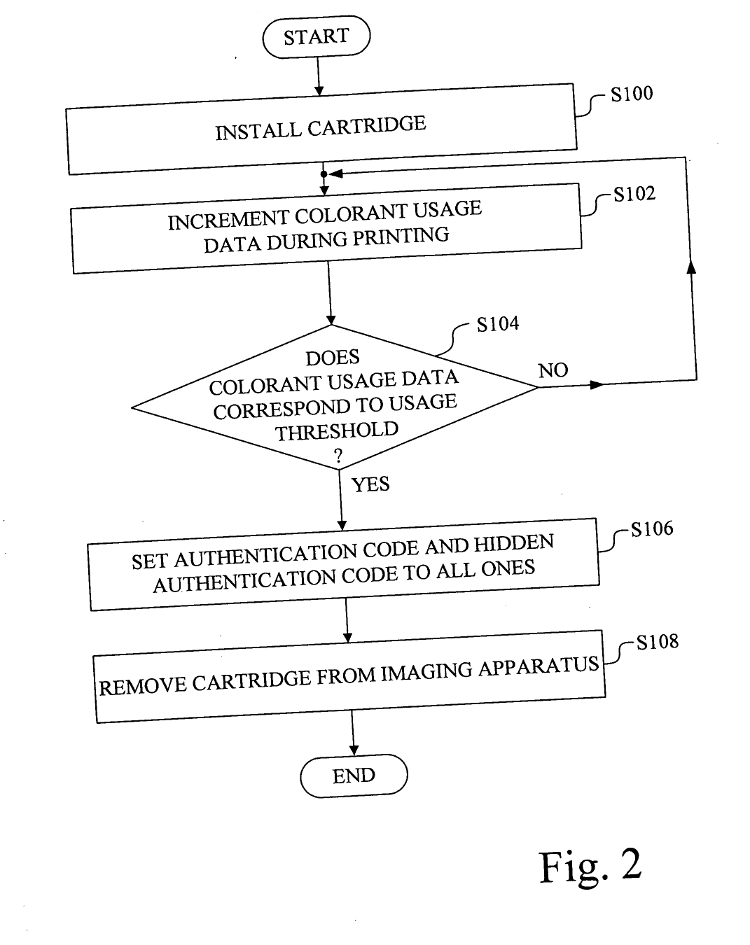

Referring now to FIG. 2, a method for identifying cartridges 22 intended for use with an imaging apparatus 12 is depicted.

In the examples that follow, the steps may be performed by a processing unit, such as, for example, controller 18, which executes program instructions for performing the respective steps, with the exception of installing cartridge 22 into imaging apparatus 12 and removing cartridge 22 from imaging apparatus 12. As set forth above, controller 18 may be, in whole or in part, in imaging apparatus 12 or host 14. Nonetheless, controller 18 is considered a part of imaging apparatus 12.

At step S100, a cartridge, such as cartridge 22, is installed into imaging apparatus 12. Once installed, controller 18 executes instructions to read the serial number of cartridge 22 from cartridge memory 24, and stores the serial number in a previous cartridge serial number list in memory, e.g., memory 36 or memory 46. The cartridge is then authenticated based on the authentication code, hidden authentication code and the serial number of the particular cartridge 22. The authentication associated with an exemplary embodiment of the present invention employs authentication codes that are determined based on the cartridge's serial number, such that each of the authentication code and hidden authentication code form a unique pair with the serial number. During authentication, mathematical algorithms, such as a hash, are employed to determine if the authentication code and hidden authentication code correspond to the serial number. If so, the particular cartridge 22 is considered valid and authenticated.

At step S102, colorant usage data is incremented during printing. Each nozzle firing is counted and stored in imaging apparatus 12, and a multiple of the number of nozzle firings is stored in cartridge memory 24. In the present embodiment, for example, increments of 10⁷ nozzle firings are stored in cartridge memory 24. Step S102 can be performed during all printing operations using imaging apparatus 12 and cartridge 22.

At step S104, a determination is made as to whether the colorant usage data corresponds to, e.g. has reached, a usage threshold indicating the exhaustion of the initial colorant supply, e.g., the ink supply, contained in cartridge 22. If not, process flow proceeds back to step S102. Otherwise, process flow proceeds to step S106.

At step S106, with the colorant supply of cartridge 22 having been exhausted, the authentication code and the hidden authentication code are set to a predetermined value (e.g., all ones, i.e., programming all bits of cartridge memory 24 that correspond to the authentication code and hidden authentication code to a value of one). It will be understood that other numerical representations may be employed without departing from the scope of the present invention. In the present embodiment, cartridge memory 24 is a one-time programmable memory, and hence, once programmed to all ones, the authentication code and hidden authentication code cannot be rewritten, such as by a potential counterfeiter.

At step S108, the exhausted cartridge 22 is removed from imaging apparatus 12 by the user.

As set forth above, the authentication code and hidden authentication code are written to a predetermined value, e.g., all ones, and accordingly, the authentication code and hidden authentication code no longer correspond to the serial number of the particular cartridge 22, and thus the particular cartridge 22 can no longer be authenticated as a “new” OEM cartridge. Since the memory is one-time programmable, it cannot be readily changed by a counterfeiter. It is thus more difficult for a counterfeiter to collect valid serial number/authentication code pairs from spent cartridges 22, and obtain used cartridges 22, refill them with ink, and pass the cartridges off as authentic new OEM cartridges. Accordingly, it is less likely that cartridges 22 will be counterfeited.

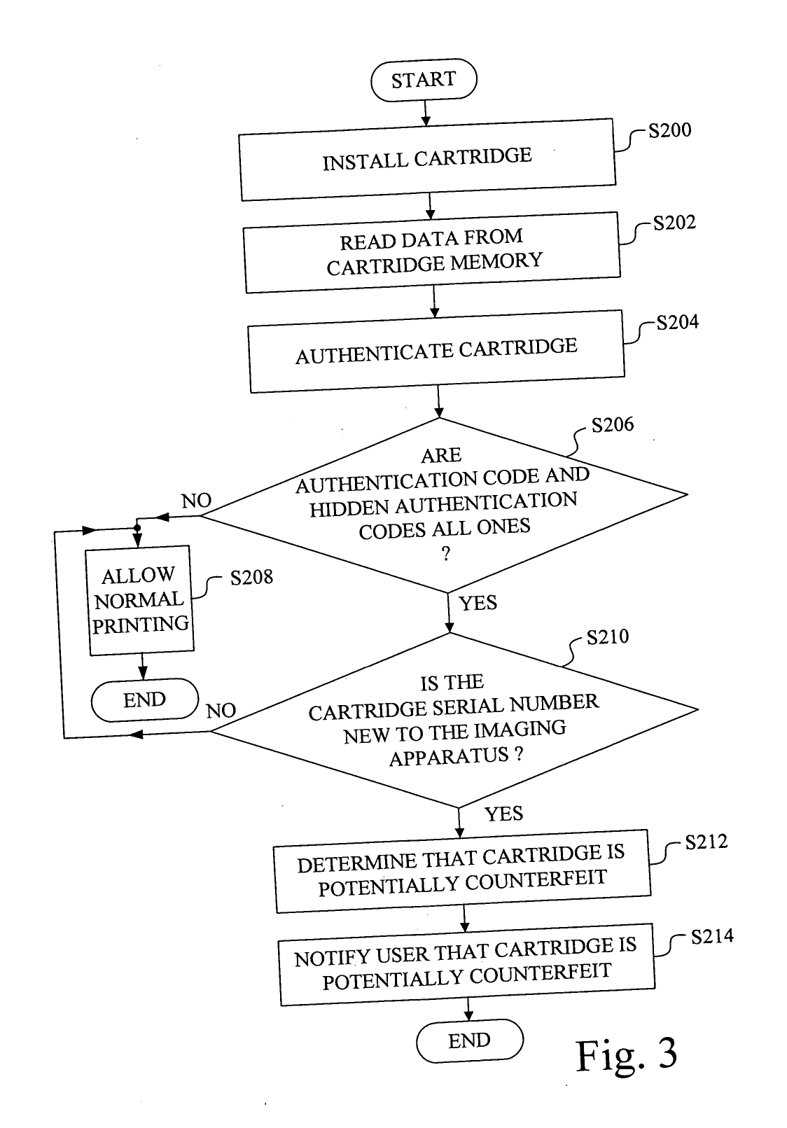

Referring now to FIG. 3, a method for identifying cartridges intended for use with an imaging apparatus is depicted, which illustrates the present inventive algorithm for determining that a cartridge is potentially counterfeit. The ultimate determination of whether cartridge 22 is counterfeit may be made, for example, upon further inspection of the particular cartridge 22 by the OEM. An exemplary embodiment of the present invention allows imaging apparatus 12 to identify authentic new OEM consumables without a connection to the internet, since all aspect of the method can be performed using imaging apparatus 12.

At step S200, a consumable, such as cartridge 22, is installed into imaging apparatus 12.

At step S202, the serial number of cartridge 22, the authentication code, and the hidden authentication code are read from cartridge memory 24.

At step S204, cartridge 22 is authenticated using the serial number of the particular cartridge 22, the authentication code, and the hidden authentication code read from cartridge memory 24.

At step S206, it is determined whether the authentication code and hidden authentication code correspond to a predetermined value, e.g., all ones. If not, process flow proceeds to step S208, wherein normal processing is continued. Otherwise, process flow proceeds to step S210.

At step S210, it is determined whether the particular cartridge 22 is new to imaging apparatus 12, based on comparing the serial number of the particular cartridge 22 with the previous cartridge serial number list. If the particular cartridge is new to imaging apparatus 12, process flow proceeds to step S212, wherein it is determined that the cartridge is potentially counterfeit.

At step S214, the user of imaging apparatus 12 may, for example, be asked whether they believe they are using an authentic OEM new consumable, such as via user interface 26 and/or display monitor 50. This allows the user to, for example, contact the OEM manufacturer to confirm whether the cartridge is counterfeit. In addition, other parts of cartridge memory 24 may be overwritten to a predetermined value in addition to and/or in place of the authentication code and hidden authentication code so as to mark the particular cartridge for later identification in accordance with the teachings of these inventions.

While these inventions have been described with respect to exemplary embodiments, it will be recognized that the present inventions may be further modified within the spirit and scope of this disclosure. This application is therefore intended to cover any variations, uses, or adaptations of the inventions using their general principles. Further, this application is intended to cover such departures from the present disclosure as come within known or customary practice in the art to which this inventions pertain and which fall within the limits of the appended claims.

What is claimed is:

1. A method for identifying a consumable intended for use with an imaging apparatus, the consumable having memory storing at least first data and second data, comprising:
incrementing said first data during printing operations using said imaging apparatus;
said imaging apparatus determining when said first data corresponds to a first predetermined value; and
setting said second data to a second predetermined value based on a correspondence of said first data to said first predetermined value.

2. The method of claim 1, wherein said first data is colorant usage data for said consumable, said first predetermined value is a usage threshold, and said imaging apparatus determining when said first data corresponds to said first predetermined value includes determining if said colorant usage data has reached said usage threshold.

3. The method of claim 1, wherein said second data is an authentication code and a hidden authentication code.

4. The method of claim 1, wherein said memory is a one-time programmable memory.

5. The method of claim 4, wherein said setting said second data to said second predetermined value is performed by programming all bits of said one-time programmable memory that correspond to said second data.

6. A method for identifying a consumable intended for use with an imaging apparatus, the consumable having a memory storing data and a serial number, comprising:
installing a consumable into said imaging apparatus;
reading said data from said memory;
determining if the consumable is new to said imaging apparatus based on said serial number; and
determining if said data corresponds to a predetermined value.

7. The method of claim 6, further comprising:
authenticating said consumable using said data,
wherein said data is an authentication code and a hidden authentication code.

8. The method of claim 6, wherein said memory is a one-time programmable memory.

9. The method of claim 6, further comprising notifying a user of said imaging apparatus with respect to the determinations.

10. An imaging apparatus configured to identify a consumable intended for use with said imaging apparatus, the consumable having a memory storing at least first data and second data, comprising:
a print engine configured to receive a consumable; and
a controller communicatively coupled to said print engine, said controller being configured to execute instructions for:
determining when said first data corresponds to a first predetermined value; and
setting said second data to a second predetermined value based on a correspondence of said first data to said first predetermined value.

11. The imaging apparatus of claim 10, wherein said first data is colorant usage data for said consumable, said first predetermined value is a usage threshold, and said determining when said first data corresponds to said first predetermined value includes determining if said colorant usage data has reached said usage threshold.

12. The imaging apparatus of claim 10, wherein said second data is an authentication code and a hidden authentication code.

13. The imaging apparatus of claim 10, wherein said memory is a one-time programmable memory.

14. The imaging apparatus of claim 13, wherein said setting said second data to said second predetermined value is performed by programming all bits of said one-time programmable memory that correspond to said second data.

15. A imaging apparatus for identifying a consumable intended for use with the imaging apparatus, the consumable having a memory storing data and a serial number, comprising:
a print engine configured to receive a consumable; and
a controller communicatively coupled to said print engine, said controller being configured to execute instructions for:
reading said data from said memory after said a consumable is received by said imaging apparatus;
determining if said consumable is new to said imaging apparatus based on said serial number; and
determining if said data corresponds to a predetermined value.

16. The imaging apparatus of claim 15, further comprising:
authenticating said consumable using said data,
wherein said data is an authentication code and a hidden authentication code.

17. The imaging apparatus of claim 15, wherein said memory is a one-time programmable memory.

18. The imaging apparatus of claim 15, further comprising notifying a user of said imaging apparatus with respect to said determinations.
